(19) United States
(12) Patent Application Publication
(10) Pub. No.: US 2003/0095920 A1
(43) Pub. Date: May 22, 2003

(54) Process of producing synthesis gas

(76) Inventors: Holger Schlichting, Hofheim (DE); Waldemar Liebner, Oberursel (DE); Rainer Morgenroth, Friedrichsdorf (DE); Christoph Erdmann, Hofheim (DE); Gerd Johann Grunfelder, Bad Homburg (DE); Helmut Fellner, Bad Homburg (DE); Jurgen Hofmockel, Frankfurt (DE)

Correspondence Address: WILLIAM GERSTENZANG, NORRIS, MCLAUGHLIN & MARCUS, P.A., 220 EAST 42ND STREET, 30TH FLOOR, NEW YORK, NY, 10017, US

(21) Appl. No.: 10/282,372

(22) Filed: Oct. 29, 2002

(30) Foreign Application Priority Data
Nov. 21, 2001 (DE) DE 101 56 980.7

(51) Int. Cl. C01B 3/26

(52) U.S. Cl. 423/651

(57) ABSTRACT

This invention relates to a process as well as a burner for producing carbon monoxide, in which liquid hydrocarbons such as e.g. oil or natural gas are non-catalytically decomposed into carbon monoxide (CO) and hydrogen (H₂) at high temperatures. The steam previously used as atomizing and cooling medium is replaced by carbon dioxide, which downstream of the reactor system is separated from the synthesis gas produced and recirculated. To reduce the expenditure of apparatus for providing the gasification medium, the carbon dioxide is withdrawn from the succeeding gas washing, supplied to the burner and expanded through one or more nozzles directly before the orifice opening for the fuel, the differential pressure of the expansion of the carbon dioxide only being 2% to 50% of the reactor pressure.

### DESCRIPTION

This invention relates to a process as well as an associated burner for producing synthesis gas, in which liquid hydrocarbons such as e.g. oil or liquid by-products of the chemical production as well as gaseous hydrocarbons such as e.g. natural gas or town gas are non-catalytically decomposed into carbon monoxide (CO) and hydrogen (H₂) at high temperatures.

This process is known under the name Multi-Purpose Gasification (MPG process) and comprises a reactor, the waste heat path, the gas cleaning and the CO₂ and H₂S washing. The central element of this technology is the burner, in which the feed materials are mixed and supplied to the reactor.

In the documents AT-B-369345 and EP-B-0127273, the operating principle of the burner is described in detail. Liquid fuel is atomized in a special nozzle by means of high-pressure steam. The water introduced by means of the atomizing steam takes part in the reaction in the MPG reactor and is partly converted to H₂. In the non-catalytic breakdown of natural gas, steam is required to avoid burner damages due to overheating. Due to the carbon-hydrogen ratio predetermined in the natural gas, only small CO/H₂ ratios can be achieved in the product gas. The use of steam deteriorates this ratio in addition. This is particularly disadvantageous when a synthesis gas with a high content of carbon monoxide is required or when the actual valuable gas is carbon monoxide itself.

In EP-B-0380988 a burner is proposed, which is suitable for introducing liquid fuels into the reactor and in which the atomization of the fuel is effected with steam or alternatively with carbon dioxide (CO₂).

What is disadvantageous in this burner is the required high excess pressure of 100% to 250% of the critical pressure ratio with which the steam or the CO₂ must be introduced into the burner. In the case of CO₂ as atomizing agent, this requires a high expenditure of energy and apparatus for the compression of CO₂.

It is the object underlying the invention to create an improved process of producing synthesis gas, in which for atomizing the fuel not only steam is used, but also other suitable gaseous media such as e.g. carbon dioxide, natural gas, town gas or waste gas or a mixture thereof, and in which the atomization of the fuel into the reaction space is effected at low cost and with little expenditure in terms of apparatus.

In accordance with the invention, this object is solved in that for producing synthesis gases through partial oxidation of liquid or gaseous fuels in the presence of oxygen or oxygen-containing gases the fuel, the oxygen-containing gas and the atomizing medium are supplied to the burner separately, and the atomizing medium is expanded through one or more nozzles directly before the orifice opening for the fuel, the differential pressure of the expansion of the atomizing medium being only 2% to 50% of the reactor pressure.

With this small required excess pressure for expanding the atomizing medium upon introduction into the burner, the expenditure for providing the atomizing medium is reduced considerably. When atomizing steam is used, the same need not be provided from a separate network or boiler with correspondingly high pressure level, but the steam necessarily generated in the waste heat boiler of the gasification reactor can be utilized as gasification medium directly or after having been slightly overheated.

When carbon dioxide is used as atomizing medium, providing carbon dioxide externally can be omitted, when the carbon dioxide from the succeeding gas washing is withdrawn from the raw synthesis gas and is then again supplied to the burner. In this case, the small excess pressure of the atomizing medium, which is required in the burner, is particularly advantageous. The required compressor, which compresses the carbon dioxide separated in the gas washing stage to the pressure required for atomization in the burner, can be equipped with less stages and requires less operating energy. Advantageously, the carbon dioxide is slightly overheated before being introduced into the burner.

As atomizing media, there can also be used other gaseous media which are available in the process itself oder in the plant, such as:

tail gas from a pressure-swing adsorption (PSA plant) or membrane plant for hydrogen recovery,

tail gas from a cold box for carbon monoxide recovery,

gases which are obtained as by-product of other processes, which in general are collected in a fuel gas network and otherwise must be burnt as a rule,

natural gas.

These gases can be supplied to the burner as atomizing medium individually, as mixture or enriched with steam.

To achieve an effective atomization, the discharge speed of the gaseous atomizing medium from the nozzle must lie in the range from 20 m/s to 300 m/s. Preferably, there is employed a discharge speed of the atomizing medium from the nozzle in the range from 40 m/s to 200 m/s. The height of the discharge speed depends for instance on the atomizing medium used as well as on the subsequently explained ratio of diameters in the nozzle.

The high discharge speed is achieved by the constructive design of the burner, in which the diameter of the nozzle outlet for the liquid fuel has a certain ratio with respect to the diameter of the nozzle orifice of the atomizing medium. The ratio of diameters is 1/1.1 to 1/5, preferably 1/1.3 to 1/3. With this design of the nozzle space there is achieved the necessary discharge speed for mixing the media. Due to this high discharge speed, less expansion can be employed in accordance with the invention.

Embodiments of the process will be explained by way of example with reference to the drawings.

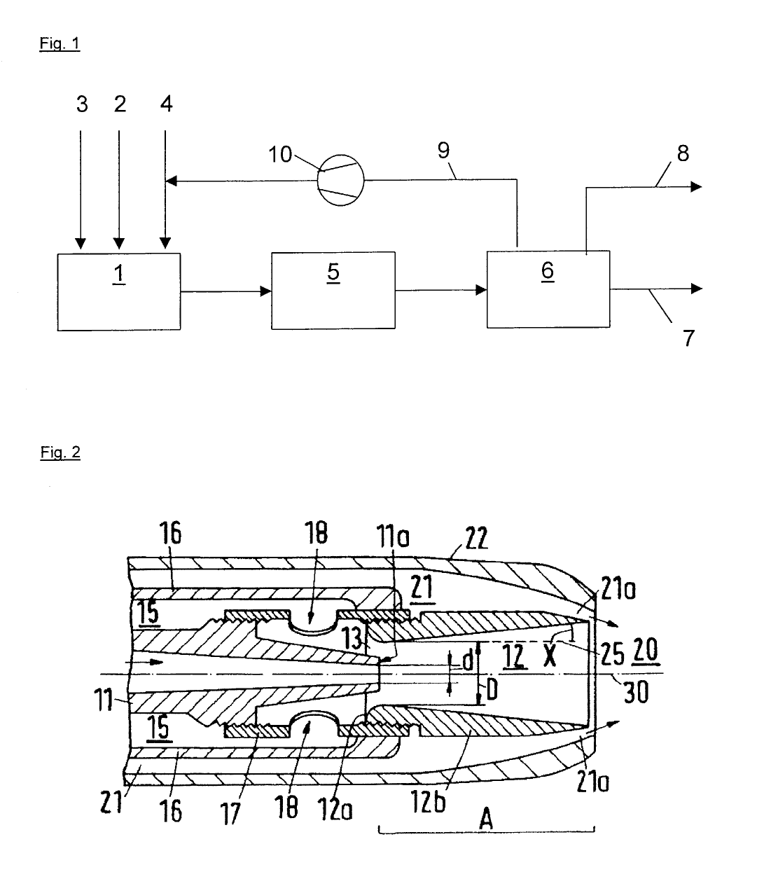

FIG. 1 shows a diagram of the process of producing carbon monoxide. In the reactor (1), a burner is disposed, which is not represented here. Into the reactor (1), liquid fuel or gas is introduced via line (2). Via line (3), the oxygen necessary for combustion is added. Another line (4) supplies the atomizing medium necessary for atomization and cooling. Said atomizing medium can for instance be provided by means of a gas tank which is not shown here. In the reactor, the feed material is gasified at temperatures of 1000 to 1500° C. and a pressure of 1 to 100 bar. During gasification, the gases CO, H₂, CO₂ are obtained. The gases are passed through a gas cooling and dedusting (5) and thereafter supplied to a gas washing (6). The product gases CO and H₂ are discharged via line (7) for further use.

When the fuel contains sulfur, the same is separated as H₂S in the gas washing and usually discharged to a Claus plant through line (8), whereas the pure carbon dioxide separated from the synthesis gas is first passed through a compressor (10) via line (9) and then recirculated to the reactor via line (4).

In FIG. 2, the principle of the MPG burner is illustrated. The liquid fuel is expanded into the premixing chamber (12) through the nozzle (11). The atomizing medium is supplied through the annular space (15) and enters the premixing chamber with a high speed from the nozzle (13). The pulsed stream of the atomizing medium effects an additional dispersion of the fuel stream into fine droplets. The oxygen-containing gas is supplied through the annular space (21) and brought in contact with the mixture of fuel and atomizing medium at the burner orifice, in direct vicinity of the inlet of the reaction space (20) which is not shown here. The constructive design depends on the properties of the liquid fuel and of the atomizing medium and on the quantitative proportions thereof. The axial length (A) of the mixing chamber (12) between the outlet opening of the liquid fuel (11a) and the inlet of the reaction space is 10 to 300 mm, preferably 20 to 200 mm. The cone angle (x) of the mixing chamber, which is measured against an axially parallel line (25), is 2 to 200 and usually 5 to 150. The largest inside diameter of the mixing chamber (12) is reached at the orifice opening and is 10 to 150 mm, preferably 20 to 90 mm. What is decisive for a fine dispersion of the liquid fuel and an intensive intermixing with the atomizing medium is the ratio of the diameter (d) of the nozzle outlet (11a) for the liquid fuel to the diameter (D) of the nozzle orifice (13) of the atomizing medium. The diameter ratio d/D is 1/1.1 to 1/5, preferably 1/1.3 to 1/3. The expansion through the nozzle (13) of the atomizing medium is adjusted such that the discharge speed of the atomizing medium is 20 to 300 m/s, usually 40 to 200 m/s.

### EXAMPLE 1

When gasifying heavy residual oil at 60 bar, CO₂ is used as atomizing medium. For comparison, the amount of steam otherwise required for atomizing purposes is replaced by the same mass of CO₂. The CO production is distinctly improved thereby, and the specific fuel consumption is reduced. The differences are represented in the Table below:

| | Steam atomization | CO₂ atomization | Change [%] |
|---|---|---|---|
| CO/H₂ ratio | 1.10 | 1.80 | +64.0 |
| synthesis gas | | | |
| Fuel consumption | 0.55 | 0.45 | −18.2 |
| kg oil/kg CO | | | |
| Oxygen | 0.57 | 0.46 | −19.3 |
| consumption | | | |
| kg O₂/kg CO | | | |

The production costs for CO are distinctly reduced, as 18% less charge oil and 19% less oxygen are consumed. The much higher CO/H₂ ratio facilitates the recovery of pure CO in a cold box or membrane plant.

### EXAMPLE 2

In a plant, pure hydrogen is produced through gasification of heavy residual oil from a refinery at 35 bar. For this purpose, the carbon monoxide of the raw gas from the MPG gasification is converted to hydrogen in a CO shift reactor by means of steam on a catalyst. The pure hydrogen is recovered from the gas by means of a pressure-swing adsorption (PSA plant). There is obtained an exhaust gas which contains H₂ (56%), CO (28%) and CO₂ (10%). Instead of supplying this exhaust gas to the town gas network and burning the same, it is compressed, mixed with steam and utilized as atomizing medium. The amount of steam supplied to the reactor can be reduced by 40%, when the exhaust gas is utilized as atomizing medium.

By recirculating the PSA exhaust gas to the reactor, the following improvements in the hydrogen production are obtained:

| | | PSA tail | |
|---|---|---|---|
| Atomizing medium | Steam | gas + steam | Change [%] |
| Oxygen consumption | 0.28 | 0.25 | −10.1 |
| m³N O₂/m³N H₂ | | | |
| Fuel consumption | 0.36 | 0.30 | −14.4 |
| kg oil/m³N H₂ | | | |

The savings with the resources oil and oxygen are larger than the expenditure for the compression of the exhaust gas, so that the expenditure for the production of hydrogen is decreased by about 3%.

1. A process of producing synthesis gas through partial oxidation of liquid or solid fuels in the presence of oxygen or oxygen-containing gases, wherein the fuel, the oxygen-containing gas and the atomizing medium are supplied to the burner separately and the atomizing medium is expanded through one or more nozzles directly before the orifice opening for the fuel, characterized in
that the differential pressure of the expansion of the atomizing medium is only 2% to 50% of the reactor pressure.

2. The process as claimed in claim 1, characterized in that as atomizing medium carbon dioxide is used, which is withdrawn from the succeeding gas washing, compressed and again supplied to the burner.

3. The process as claimed in claim 2, characterized in that the carbon dioxide is supplied to the burner directly or after having been slightly overheated.

4. The process as claimed in claim 1, characterized in that as atomizing medium there is used tail gas from a PSA plant or membrane plant or from a cold box for the recovery of carbon monoxide.

5. The process as claimed in claim 4, characterized in that the tail gas is compressed before it is supplied to the burner.

6. The process as claimed in claim 1, characterized in that the atomizing medium is discharged from the diffusor with a speed of 20 m/s to 300 m/s.

7. The process as claimed in claim 1, characterized in that the atomizing medium is discharged from the diffusor with a speed of 40 m/s to 200 m/s.

8. A burner for producing synthesis gases through partial oxidation of liquid or solid fuels in the presence of oxygen or oxygen-containing gases, wherein the fuel, the oxygen-containing gas and the atomizing medium are supplied to the burner separately and the atomizing medium is expanded through one or more nozzles directly before the orifice opening for the fuel, characterized in that the ratio of the diameter (d) of the nozzle outlet (11a) for the liquid fuel to the diameter (D) of the nozzle orifice (13) of the atomizing medium lies in the range from 1/1.1 to 1/5.

9. The burner as claimed in claim 7, characterized in that the ratio of the diameter (d) of the nozzle outlet (11a) for the liquid fuel to the diameter (D) of the nozzle orifice (13) of the atomizing medium lies in the range from 1/1.3 to 1/3.

10. The burner as claimed in claim 7, characterized in that the axial length of the mixing chamber from the outlet opening of the fuel to the inlet of the reaction space is 10 to 300 mm, preferably 20 to 200 mm.

11. The burner as claimed in claim 7, characterized in that the cone angle of the mixing chamber is 2 to 200, preferably 5 to 150.

12. The burner as claimed in claim 7, characterized in that the largest inside diameter of the mixing chamber at the orifice opening is 10 to 150 mm, preferably 20 to 90 mm.
